(19) United States
(12) Patent Application Publication
(10) Pub. No.: US 2016/0342670 A1
(43) Pub. Date: Nov. 24, 2016

(54) DEVICE DATA SYNCHRONIZATION

(71) Applicant: PREVENTICE, INC., Rochester, MN (US)

(72) Inventors: Richard M. SMITH, Oronoco, MN (US); Elvis A. BUDIMLIC, Rochester, MN (US); Gregory S. WOBIG, Rochester, MN (US); Scott BURRICHTER, Rochester, MN (US)

(21) Appl. No.: 14/717,640

(22) Filed: May 20, 2015

(51) Int. Cl. G06F 17/30; G06F 19/28; H04L 29/08

(52) U.S. Cl. CPC G06F 17/30575; H04L 67/1095; G06F 19/28

(57) ABSTRACT

Techniques for synchronizing data between a first device and a second device. A plurality of data elements relating to a care plan in a health care environment are created and a respective unique identifier is assigned to each of the plurality of data elements. Embodiments transmit a synchronization request to a second device, specifying at least (i) one or more identifiers assigned to data elements to synchronize, (ii) a session identifier indicating when a last synchronization operation was performed at the first device and (iii) one or more data element values that have been modified since the last synchronization operation was performed. In response, a second one or more data element values are received from the second device, corresponding to the one or more identifiers specified in the synchronization request. The first device updates the one or more data elements corresponding to the second one or more data element values.

### BACKGROUND

1. Field

Embodiments presented herein generally describe software tools for health care, and more specifically, for synchronizing data between computer devices used to administer a care plan.

2. Description of the Related Art

The Internet of Things (IoT) generally refers to the ability of many devices, aside from conventional computing platforms, to connect to computer networks. In the health care field, the ability to network virtually any devices allows a person's health to be monitored outside of a hospital or physician office. For example, network aware devices may be embedded in clothing, worn using a support device, or located in user's house. Sensors in such devices can communicate with a mobile device carried by the user (e.g., a mobile phone or tablet) or a remote system over a network. The mobile device can forward data received from the sensors to remote computing systems for processing as well as perform processing locally.

Using the data retrieved from the sensors, a physician can monitor the health of the patient remotely. For example, a physician can check in on a patient to monitor her heart rate, blood pressure, or check for changes in weight using the data collected by the sensors. The physician can then determine whether a change to the patient's treatment is needed—e.g., changing medication dosage, scheduling an additional physician visit, and the like.

### SUMMARY

One embodiment provides a method for synchronizing data between a first device and a second device. The method includes creating a plurality of data elements relating to a care plan in a health care environment for a patient. Additionally, the method includes assigning a respective identifier to each of the plurality of data elements, where each assigned identifier is unique within the health care environment. The method also includes transmitting a synchronization request to a second device, specifying at least (i) one or more identifiers assigned to data elements to synchronize, (ii) a session identifier indicating when a last synchronization operation was performed at the first device and (iii) one or more data element values that have been modified since the last synchronization operation was performed. The method further includes, in response, receiving a second one or more data element values from the second device, corresponding to the one or more identifiers specified in the synchronization request. Moreover, the method includes updating, at the first device, the one or more data elements corresponding to the second one or more data element values.

Another embodiment provides a non-transitory computer-readable medium containing computer program code that, when executed by a processor, performs an operation for synchronizing data between a first device and a second device. The operation includes creating a plurality of data elements relating to a care plan in a health care environment for a patient. The operation also includes assigning a respective identifier to each of the plurality of data elements, where each assigned identifier is unique within the health care environment. Additionally, the operation includes transmitting a synchronization request to a second device, specifying at least (i) one or more identifiers assigned to data elements to synchronize, (ii) a session identifier indicating when a last synchronization operation was performed at the first device and (iii) one or more data element values that have been modified since the last synchronization operation was performed. The operation further includes, in response, receiving a second one or more data element values from the second device, corresponding to the one or more identifiers specified in the synchronization request. Moreover, the operation includes updating, at the first device, the one or more data elements corresponding to the second one or more data element values.

Yet another embodiment provides a system that includes a processor and a memory containing a program that, when executed by the processor, performs an operation for synchronizing data between a first device and a second device. The operation includes creating a plurality of data elements relating to a care plan in a health care environment for a patient. Additionally, the operation includes assigning a respective identifier to each of the plurality of data elements, where each assigned identifier is unique within the health care environment. The operation also includes transmitting a synchronization request to a second device, specifying at least (i) one or more identifiers assigned to data elements to synchronize, (ii) a session identifier indicating when a last synchronization operation was performed at the first device and (iii) one or more data element values that have been modified since the last synchronization operation was performed. The operation further includes in response, receiving a second one or more data element values from the second device, corresponding to the one or more identifiers specified in the synchronization request. Moreover, the operation includes updating, at the first device, the one or more data elements corresponding to the second one or more data element values.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates an example computing environment, according to one embodiment described herein.

FIG. 2 illustrates a parallel processing computing environment, according to one embodiment described herein.

FIG. 3 illustrates an event engine for processing received health events, according to one embodiment described herein.

FIG. 4 is a block diagram illustrating care plan devices arranged in a hierarchical topology, according to one embodiment described herein.

FIG. 5 is a flow diagram illustrating a method of synchronizing data between devices, according to one embodiment described herein.

FIG. 6 is a flow diagram illustrating a method of synchronizing data at an intermediary device, according to one embodiment described herein.

FIG. 7 is a flow diagram illustrating a method of synchronizing data between devices, according to one embodiment described herein.

FIG. 8 is a block diagram illustrating a computing device, according to one embodiment described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Network aware devices provide a variety of opportunities for a care provider (e.g., a physician, nurse, technician, etc.) to improve patient care. An event manager can use the data provided by network aware devices or an “internet of things” (IoT) device to identify health events that range from identifying critical health care issues such as cardiac or respiratory emergencies to maintenance events where the network aware device fails, e.g., because a battery is low or a wire is disconnected. To process health related events, an event manager may process events using a collection of defined paths.

In one embodiment, a group of servers each host an event engine with a respective set of interconnected tasks and queues that form a workflow. The group of servers may include a load balancer which routes the biometric measured by the IoT devices to one of the servers for processing. Because the data is processed using different tasks, the event engines can process multiple health events simultaneously. Stated differently, the event engines process the health events using a series of steps in the workflow where each step (or task) can process a respective health event in parallel.

Generally, the event engines classify health events received from the body worn sensor devices. For example, a device may have classified the health event as one type of event. However, the workflows in the event engines may process the biometric data associated with the event to confirm the initial classification or reclassify or reprioritize the health event as a different type of event. Alternatively, the sensor device may send biometric data to the servers which then use one or more thresholds or rules to identify health events which are then processed by the workflows in the event engines. The workflows determine actions to take when processing the health events such as notifying a care provider, suppressing or ignoring the event, or storing the event in a data repository.

With the introduction of mobile devices and social/collaborative applications, it is desirable to allow data to be updated on an individual's own devices or to allow the data to be manipulated by multiple users on their own devices simultaneously. In a health care environment for administering a care plan for a patient, data synchronization between computing devices is a constant challenge, as data is constantly being collected and modified at the various computing devices. For example, various sensor devices can generate substantial amounts of biometric data for the patient, while computing devices for the health care provider can generate changes to the patient's care plan. In such an environment, data synchronization techniques can be used in order to ensure that the various computing devices within the environment are operating with the most current data.

In many environments, particular computing devices may be offline for periods of time, during which these devices are unable to send and receive data for synchronizing with other devices. This can be particular problematic for devices with an intermittent network connection (e.g., devices relying on a cellular network connection). That is, given the transient nature of the cellular network (or even the WiFi network), by the time a device is able to send data, the data may have already been updated from another device and the update is now obsolete.

As such, embodiments described herein provide mechanisms for synchronizing data across multiple sources, where any of those sources could be updating any of the data at any time. Moreover, embodiments may be used in environments where the various computing devices may periodically be unable to access a master copy of the database (e.g. a mobile device that is not within network range), as protocols described herein can determine which devices need to send and receive which data.

One embodiment provides techniques for synchronizing data between devices (e.g., a mobile device configured to collect biometric data for a patient using sensor devices, a computing device for use by health care providers to edit a patient's care plan, a database server, etc.). A first device can transmit a synchronization (also referred to herein as “sync”) request to a second device to initiate a sync operation. For instance, the sync request could include one or more identifiers assigned to data elements to be synchronized. As an example, a patient's mobile device could transmit such a sync request to a database server upon obtaining network connectivity, and the sync request could include an identifier(s) corresponding to the patient's care plan to ensure the mobile device is administering the latest version of the care plan.

The sync request could also specify a session identifier value for each data element identifier within the request. Generally, the session identifier values are watermark values that indicate when the last sync operation was performed for the respective data element. In one embodiment, the session identifier values correspond to the value of a counter that is incremented each time a sync operation is performed. In such an embodiment, after updating a particular data element value as part of a sync operation, logic on the device can increment the current session identifier value and can tag the updated data element value with the incremented session identifier value.

Additionally, the sync request can include one or more data element values that have been modified on the first device since the last sync operation performed by the first device. That is, not only could the first device's data be outdated due to the first device is loss of network connectivity for a period of time, but other devices in the health care environment could have outdated data because they do not include the data updates performed on the first device during the first device is loss of connectivity. As such, the sync request can include data modifications made on the first device since the last sync operation, including new data element values (e.g., newly collected biometric data for the patient), modified data element values (e.g., a change to a threshold value in a patient's health care plan), deleted values (e.g., a deleted condition in a patient's health care plan), and so on.

Upon receiving the sync request from the first device, the second device can process the included data element modifications. For instance, if the second device determines that a data element modification within the sync request is more recent than a copy of the data element on the second device, the second device could incorporate the data element modification into its local data repository. As an example, upon determining that the session identifier within the synchronization request is more recent than a second session identifier for a corresponding copy of the data element maintained at the second device, the second device could update the first data element based on the one or more data element values specified within the synchronization request. As another example, upon determining that the session identifier within the synchronization request is older than a second session identifier for the corresponding data element maintained at the second device, the second device could simply discard the data modification.

In addition to updating the data repository on the second device in response to the sync request, the second device can be configured to return data values to the first device. For instance, the second device could identify data elements in the second device's data repository having a respective session identifier that is more recent than the session identifier specified within the synchronization request. That is, the second device could identify data elements that have been updated more recently than the session identifier specified within the sync request. The second device could then transmit data values for the identified data elements to the first device, and the first device could update its local data repository based on the received data values. Doing so provides a way of synchronizing the first device and the second device, even when one of the devices loses network connectivity for some period of time.

### Care Plan Environment

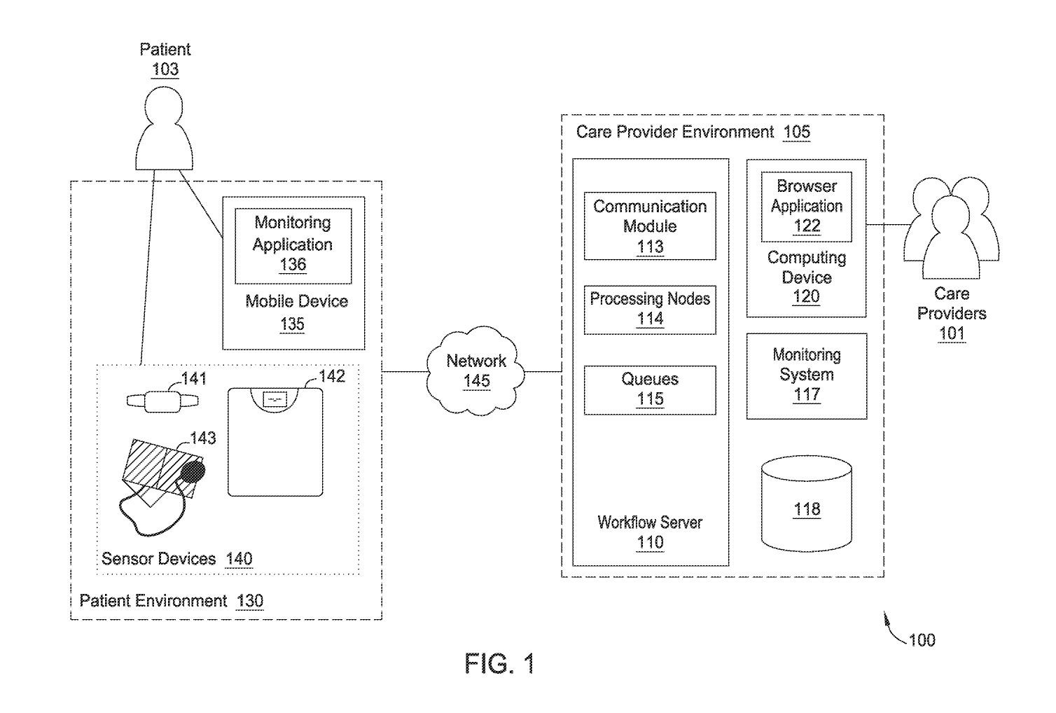

FIG. 1 illustrates an example computing environment 100, according to one embodiment. As shown, the computing environment 100 may include a care provider environment 105 and a patient environment 130, each connected to one another via a network 145. The environments 105 and 130 allow a care provider 101 (e.g., a technician, nurse, physician, etc.) to monitor biometric data generated by the patient 103.

The care provider environment 105 includes workflow server 110, a computing device 120, monitoring system 117 and data repository 118. Each of the workflow server 110, device 120, and monitoring system 125 may be a physical computing system that includes one or more computing devices or a virtual computer instance (e.g., executing in a cloud computing platform). A care provider 101 may use the computing device 120 to access (e.g., via a browser application 122, a native application on device 120, etc.) a user interface (UI) hosted by the monitoring system 117.

The workflow server 110 includes applications and data executed to identify and handle health events corresponding to patients 103. As shown, workflow server 110 includes a communication module 113, processing nodes 114, and queues 115. In one embodiment, the processing nodes 114 are software code or applications that perform a predetermined task or action on received data (e.g., health events). The workflow server 110 evaluates data received from the patient environment 130 using a set of interconnected processing nodes 114 and queues 115 which form a workflow. As biometric data or health events are received from the patient environment 130, the workflow may classify (or reclassify) the data to identify a type of the health event—e.g., presentation or notification to patient/care provider, suppression, classification, aggregation, computation, prioritization/triage, and the like. For example, different types of data received from the patient environment 130 may trigger different types of health events—e.g., an irregular heartbeat may trigger a cardiac event, while a signal indicated an electrode has become detached triggers a maintenance event. In one embodiment, the sensor devices 140 or monitoring application 136 may have performed an initial classification of the data or health events. Nonetheless, the workflow server 110 may evaluate the biometric data (or maintenance data) to confirm that this initial classification was correct.

Each type of health event may take a different path through the workflow. That is, different health events may traverse the processing nodes 114 and queues 115 using different paths. For example, a cardiac event may be evaluated using different processing nodes 114 in the server 110 than a maintenance event. Furthermore, paths through the workflow for the same health event may differ based on a variety of factors such as the severity of the health event, age of the patient 103, other symptoms exhibited by the patient 103, medication taken by the patient 103, and the like. For example, a high priority cardiac event may skip one or more processing nodes 114 or queues 115 and be immediately displayed to a care provider 101 using the monitoring system 117.

The communication module 113 permits the workflow server 110 to receive data from the patient environment 130 and transmit data to the care providers 101. The communication module 113 may receive data from the sensor devices 140 which is used to identify a health event and a corresponding path through the interconnected processing nodes 114 and queues 115. The communication module 113 can use monitoring system 117 and computing device 120 to help the care providers 101 complete the workflow. Moreover, in addition to receiving information from the patient environment 130, the communication module 113 may enable the workflow server 110 to transmit requests or instructions to the patient environment 130 such as asking the patient 103 if she has any symptoms or instructing the patient 103 to reattach a disconnected electrode.

In one embodiment, the path used by a health event to traverse the workflow server 110 may include processing nodes 114 that process health events without user intervention as well as processing nodes 114 that require input from the care providers 101. For example, a processing node 114 may filter or screen a health event to determine what queue to place the event, compare the event to one or more rules to determine an action to perform, or store the event. Alternatively, some processing nodes 114 may require the care provider 101 to perform an action or provide instructions. For example, the monitoring system 117 may generate a UI for a health event which is then displayed to the care provider 101 by the browser application 122. Once the care provider 101 performs an action (e.g., confirms the classification of the event or agrees with an action suggested by the workflow server 110), the remaining steps of the workflow are performed—e.g., send a notification to the patient 103, log the event in the history of the patient 103, route the event to a different care provider 101, reclassify the event (if the care provider 101 indicated the initial classification was incorrect), or prioritize or triage the event.

As shown, patient environment 130 includes a mobile device 135 and sensor devices 140. The mobile device 135 includes a monitoring application 136 which permits communication between the sensor devices 140 and the care provider environment 105 via network 145. The monitoring application 136 may configure one or more sensor devices 140 (e.g., IoT devices) to monitor one or more patients' biometric data as specified by a care plan. For example, the application 136 could configure logic on a heart rate monitor device worn by the patient to monitor the patient's heart rate. In turn, the monitoring application 136 can send the heart rate data to the workflow server 110 which determines if a heath event is triggered, and if so, executes a workflow to process the event as described above. In another embodiment, the heart rate monitor device, upon detecting that a threshold condition has been satisfied, could generate and transmit a health event to the mobile device 135, which in turn transmits the event to the workflow server 110 for processing. However, in other embodiments, some of the tasks performed by the workflow server 110 may be performed by the mobile device 135. That is, the workflow may include tasks performed by the mobile device 135 or sensor device 140 as well as tasks performed by the workflow server 110.

In one embodiment, the monitoring application 136 receives environmental data from the sensor devices 140. Generally, the environmental data informs the monitoring application 136 of environmental conditions in an area proximate to the sensor device 140 and the user—e.g., a room in which the user is located. For example, the sensor devices 140 may detect the air quality or pollen count for a user who has a respiratory ailment. In another example, the sensor devices 140 may track the user's movements or actions in an environment such as how many times at night the user goes to the bathroom or if the user is tossing and turning at night. This environmental data can then be used by the monitoring application 136 by itself, or in combination with the biometric data, to trigger health events which are processed by the workflow server 110.

In one embodiment, the monitoring application 136 may use an output device (e.g., a display or audio system) on the mobile device 135 to provide information to the patient 103. For example, when executing a workflow, a processing node 114 may ask the patient 103 if she is experiencing any symptoms. To get the patient's feedback, the monitoring application 136 may display a UI on the mobile device 135 which permits the patient 103 to list symptoms. Moreover, the application 136 may also display general information related to a care plan or the sensor devices 140 such as the patient's heart rate or weight, status of the sensors devices 140, etc.

In one embodiment, sensor devices 140 interact with monitoring application 136 and assist the patient 103 in reporting patient vitals and other information to the care provider environment 105. As shown, such sensor devices 140 may include a body sensor 141, a weighing scale 142, and a blood pressure cuff 143. Each of the sensor devices 140 may capture different vitals of the patient 103. For example, when applied to the body of patient 103, the body sensor 141 captures biometric data (e.g., heart rate, ECG data, etc.) in real-time. In addition, each of the sensor devices 140 may be configured to transmit the body-related metrics electronically to the monitoring application 136 on the mobile device 135. In turn, the monitoring application 136 sends the captured metrics to the workflow server 110 which can be used to trigger health events which are processed using the processing nodes 114 and queues 115.

In one embodiment, upon detecting an observation threshold has been reached, the sensor devices 140 perform an initial classification of the health event. In a particular embodiment, the mobile device 135 is configured to perform the initial classification of the health event. For example, the body sensor 141, upon detecting that the ECG data collected from the patient 103 indicates an erratic heart behavior, could classify the health event as a cardiac event. This initial classification, along with the relevant ECG data (e.g., ECG data a predetermined length of time before and after the event), could be transmitted to the mobile device 135 (e.g., over a Bluetooth® communications link) where the monitoring application 136 forwards the health event data on to the workflow server 110 over the network 145 (e.g., the Internet). Alternatively, instead of classifying the data, the monitoring application 136 may forward the raw, unprocessed sensor data to the event manager 110 which uses one of the processing nodes 114 to identify and classify health events which are then processed in the workflow server 110.

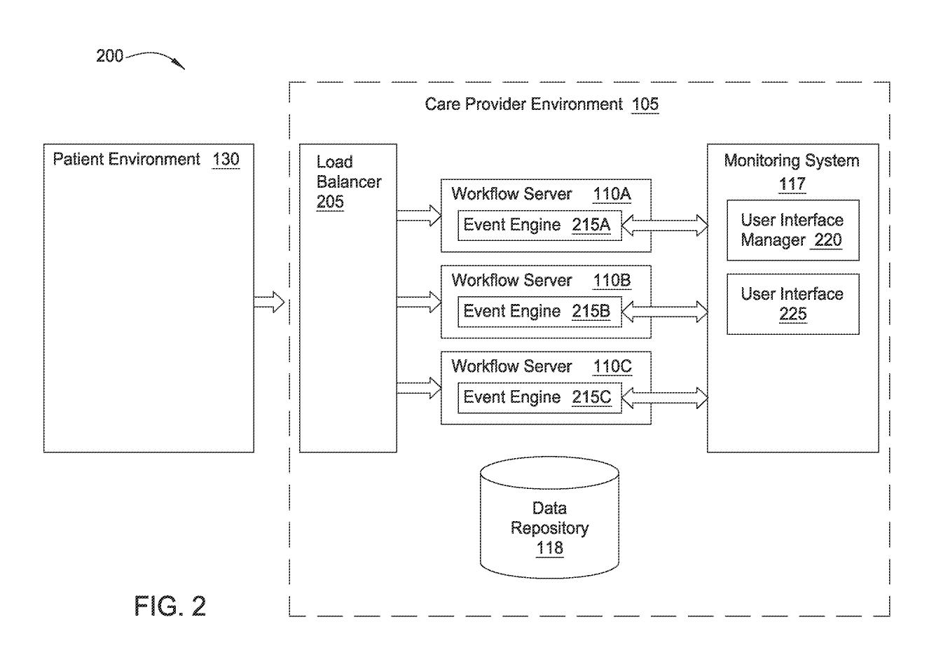

FIG. 2 illustrates a parallel processing computing environment 200, according to one embodiment. As shown, the patient environment 130 transmits biometric data or health events to the care provider environment 105 which includes a load balancer 205. The workflow servers 110 each include an event engine 215. Although not shown, each event engine 215 includes a plurality of interconnected processing nodes and queues that form a workflow for processing health events as discussed above. In one embodiment, the event engines 215 each includes the same processing nodes and queues arranged in the same manner such that any one of the event engines 215 can process the different health events generated by the sensor devices—i.e., any one of the event engines 215 can process a cardiac event, respiratory event, maintenance event, etc. Based on current workload, the load balancer 205 transmits received data or heath events to one of the servers 110 for processing. For example, the load balancer 205 may assign the received health events in a round robin manner or by monitoring the CPU or memory usage of the servers 110.

Alternatively, the event engines 215 may have different processing nodes and queues (or a different arrangement of the nodes and queues) such that the event engines 215 are configured to process different event types. For example, event engines 215A and 215B may have workflows that process cardiac events (and have the same processing nodes and queues), while the workflow in event engine 215C processes respiratory events. The load balancer 205 may determine which event engine 215 should receive the health event using the initial classification provided by the patient environment 130 or based on which sensor device measured the biometric data.

Regardless whether the event engines have the same arrangement or different arrangements, compute resources can easily be adjusted in response to varying workloads. For example, as more sensor devices are added to the patient environment 130, a system administrator can add additional workflow servers 110 to process the increased number of received health events. The reverse is also true. If the number of health events decreases, the administrator may remove one or more of the workflow servers 110. For example, if event engine 215A and 215B both process cardiac events but the number of cardiac events has decreased, the system administrator may remove one of the servers 110A or 110B.

Monitoring system 117 includes a UI manager 220 and UI 225. As discussed above, the processing nodes may require input from a care provider in order to route the health events through the event engines 215. To do so, the event engines 215 transmit requests to the UI manager 220 which generates a UI 225 which can be displayed to a care provider. For example, the UI manager may generate a UI 225 that includes an electrocardiogram (ECG) chart corresponding to a cardiac event. Further, the UI 225 may include I/O features (e.g., buttons or pull down menus) that the care provider can use to provide input or instructions to the event engine 215. For example, the care provider may instruct the event engine 215 to store the cardiac event in the data repository 118, send the cardiac event to a queue that is monitored by another care provider (e.g., to get a second opinion), or forward the cardiac event to the patient's primary physician. Thus, the monitoring system 117 permits the workflow servers 110 to output information to a care provider as well as receive instructions from the care providers.

The event engines 215 may store data in and retrieve data from the data repository 118. For example, the event engines 215 may maintain a patient history by storing all the received health events (or selected health events) derived based on monitoring a patient's vitals in the repository 118. Further, the event engines 215 may use the data stored in the data repository 118 to process the health events. For example, if the event engine 215 receives biometric data indicating the current weight of a patient, the engine 215 can retrieve past weight measurements for the patient from the data repository 118 and derive a trend graph detailing how the patient's weight has changed over time. For instance, the patient's current weight may not be enough to trigger a health event, but the patient's derived weight change over a period of time may trigger a health event. As discussed below, these derived trends may be used to generate a derived observation.

In one embodiment, the event engines 215 prioritizes health events, which, in turn, determines how quickly the health events are processed by the workflows in the engines 215 or what processing nodes and queues are used to process the health events. As discussed above, the health events may be prioritized based on a severity of the event, the type of the health event, a characteristic of the patient whose biometric data generated the health event, and the like.

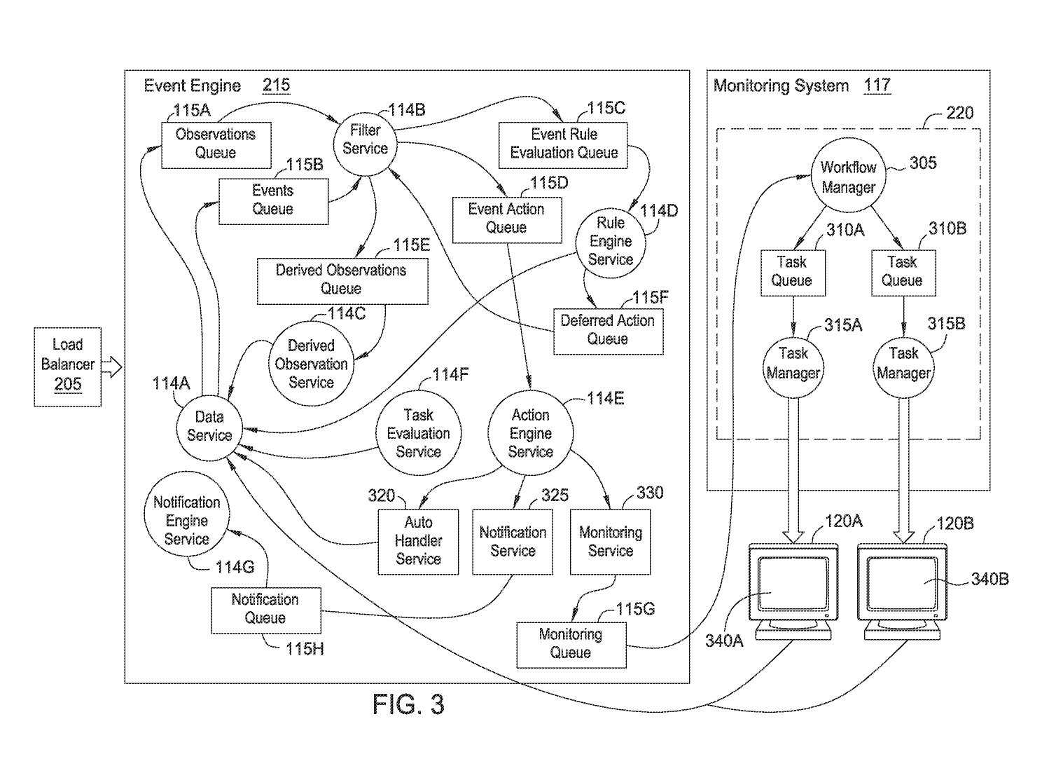

FIG. 3 illustrates an event engine 215 that includes a workflow for processing health events, according to one embodiment. As described above, a health event or biometric data received from the sensors is forwarded from the load balancer 205 to the event engine 215. Specifically, a data service node 114A in the workflow receives the forwarded information from the load balancer 205. If the load balancer 205 forwards a health event, the data service node 114A classifies the health event based on type (e.g., a cardiac, respiratory, or maintenance event). In some cases, the health event was classified before being received by the data service node 114A. Nonetheless, the data service node 114A may review the data associated with the health event such as ECG data, breathing rate, blood pressure, etc. using more compute intensive techniques to determine whether the initial classification was correct. In another example, the data service node 114A may provide a more detailed classification of the health event than the initial classification. For example, the sensor device may have generated the health event because it detected an irregular heartbeat. However, the data service node 114A may evaluate the heartbeat and classify the health event as a specific cardiac health event—e.g., a ventricular trigeminy event or an atrioventricular block event. The data service node 114A may save the classification of the health event which is used by downstream nodes and queues to process the health event.

Instead of receiving a health event, the data service node 114A may receive raw data or observations from the patient environment. That is, the raw data or observations may not have been evaluated by a sensor device worn by the patient to determine if this data triggers a health event. For example, observation data from a sensor includes blood pressure measurements, weight measurements, ECG data, and the like. As discussed below, the event engine 215 evaluates these observations and can trigger health events which are then processed in the engine 215.

The data service node 114A forwards the observations to the observation queue 115A and the health events to the events queue 115B. A filter node 114B pulls the observations and health events stored in the queues 115A and 115B. This node 114B serves as a gatekeeper that determines where the health events and observations are routed for further processing. When evaluating observations, the filter node 114B may determine whether to ignore (i.e., drop) the observations or forward the observations to a derived observation queue 115E. For example, observations such as low battery signals, start signals indicating a sensor device has started collecting biometric data, or stop signals indicating a sensor device has stopped may be ignored by the filter service node 114B. In contrast, the node 114B may forward observations such as weight measurements, blood pressure measurements, ECG data, and the like to the derived observation queue 115E. In this manner, the filter service node 114B screens the incoming observations to determine whether they should be processed further such as checking for triggering health events.

Observations forwarded by the filter service node 114B are then processed by a derived observation service node 114C. This node 114C uses received observations in conjunction with previously received observations to create new observations or to generate a new health event. Stated differently, the derived observation service 114C may aggregate previously received observations with the currently received observations to compute statistics, trends, trigger health events, and the like. Although not shown, node 114C may be communicatively coupled to the data repository which stores past observations. For example, if the currently received observation is a weight measurement, the derived observation service node 114C may evaluate this measurement with previous weight measurements to determine a weight change for the patient over a defined period of time. This weight change may trigger a health event which is then forwarded to the data service node 114A for further processing. Even if a health event is not triggered, the derived observation service node 114C may store a derived observation (e.g., a weight change, average blood pressure, heart rate trends, etc.) in the data repository so that this data is available when further observations for the patient are received by the event engine 215 (or other event engines 215).

In one embodiment, health events may be processed by the derived observation service node 114C. For example, a sensor device may trigger a health event upon determining a patient's average blood pressure for a day exceeds a threshold. The filter service node 114B may forward this health event to the derived observation service node 114C which then may use past blood pressure measurements for that patient to derive a weekly or monthly average blood pressure for the patient, or a blood pressure trend graph. Based on this derived observation, the node 114C may generate a new health event or decide to drop the health event if the derived observation does not satisfy a corresponding condition.

Further, filter service node 114B also includes logic for determining whether received health events should be dropped, forwarded to an event action queue 115D, or forwarded to the event rule evaluation queue 115C. For example, a system administrator may determine that some health events are not relevant for certain patients. The logic in the filter service node 114B may identify and drop these health events to prevent them from propagating through the rest of the event engine 215. For instance, a patient may have a heart murmur that constantly results in a sensor device triggering a health event. Rather than continually processing these health events, a care provider can instruct the filter service node 114B to screen out (or suppress) these health events from the patient.

If a received health event has a corresponding action or actions, the filter service nodes 114B forwards the health event to the event action queue 115D. However, if the action for a health event has not yet been identified, the filter service node 114B forwards the health event to the event rule evaluation queue 115C. A rule engine service node 114D pulls the health events from the queue 115C and evaluates the health event using one or more rules. Example rules include determining whether daily weight change and average blood pressure exceed respective thresholds. Based on this evaluation, the node 114D may determine what action the event engine 215 should perform—e.g., suppress/ignore the event, auto handle the event, display the event to a care provider, or delay processing the event. Once the action is determined, the rule engine service node 114D generates and forwards a new health event that includes the corresponding action to the data service node 114A. Now that the corresponding action is known, once the new health event reaches the filter service node 114B, it forwards the event to the event action queue 115D rather than the event rule evaluation queue 115D.

The rule engine service node 114D may delay processing the health event by forwarding the event to a deferred action queue 115F. The node 114D may do so when there is not enough available computing power to perform the rule evaluation or if the rule evaluation has not yet completed. That is, if all of the rules have not yet been evaluated and further evaluation is required before triggering the event action, then the event may be placed in queue 115F. For example, the rule may trigger a cardiac event but the system must first check to determine if that event is suppressed for the patient before taking the corresponding action. As shown, the health events stored in the deferred action queue 115F are then retrieved by the filter service node 114B and can be reintroduced into the event rule valuation queue 115C at a later time—i.e., when all the rules have been evaluated.

Once a corresponding action for a health event is known and the health event is stored in the event action queue 115D, an action engine service node 114E routes the health event to the appropriate action service—i.e., auto handler service 315, notification service 320, or monitoring service 325. The auto handler service 315 may perform actions that do not require supervision or input by a care provider—e.g., stores the health event in the data repository. As another example, the auto handler service 320 may assign a priority or severity to the health event before the event is reintroduced into the workflow with the new priority. The auto handler service 320 may also generate a new health event when, for example, a health event shows a cardiac event but the data quality is low. In response, the service 320 may introduce a maintenance event for checking the sensor connection/electrodes.

The event engine 215 uses notification service 325 to send information to the patient, a care giver, car provider, or device regarding the health event. The notification service 325 may include different communication channels or techniques for communicating with the patient such as email, chat, SMS messages, etc. Although FIG. 3 illustrates only one notification queue 115H and notification engine service node 114G for handling requests, the event engine 215 may have different queues and notification nodes for the different communication techniques. For example, if a maintenance event is triggered when an electrode is unplugged from a sensor device, the notification service 325 may transmit an email to the patient's mobile device instructing the patient to plug in the electrode. Alternatively, if a respiratory event is triggered because of an elevated breathing rate, the notification service may send an SMS message to the patient asking her if she is currently performing a physical activity.

The monitoring service 330 communicatively couples the event engine 215 to the monitoring system 117. When input from a care provider regarding a health event is desired, the monitoring service 330 forwards the health event to a monitoring queue 115G. The UI manager 220 in the monitoring system 117 includes a workflow manager node 305 that pulls health events from the monitoring queue 115G and assigns them to either task queue 310A or 310B. The UI manager 220 also includes task manager nodes 315A and 315B which generate UIs for the health events. These UIs are then displayed to care providers via the computing devices 120A and 120B. Further, the task manager nodes 315 may place the biometric or maintenance data associated with the health events in the UIs. For example, a UI for a cardiac event may display an ECG graph and a baseline chart, while a UI for respiratory event displays a breathing rate and oxygen levels in the blood. In this manner, the UI manager 220 can generate a customized UI for the different health events.

The computing devices 120 may transmit information to the data service node 114A of the event engine 215 which can be used to generate new health events or update current health events. For example, the care provider may instruct the event engine 215 to take a certain action such as forwarding the health event to a different care provider to get a second opinion, reclassifying the health event, suppressing or ignoring the health event, notifying a health care provider, and the like. Based on the care provider's input, the event engine 215 again routes the health event through the nodes 114 and queues 115.

The event engine 215 also includes a task evaluation service node 114F. Unlike the other nodes and queues in event engine 215 which process or store observation data or health events received from the patient environment, the task evaluation service node 114F determines whether to trigger a health event based on a care protocol or care plan. In one embodiment, the node 114F triggers a health event when the patient does not follow the care protocol or plan. For example, the care protocol may ask that the patient wear a sensor device for certain amount of time during the day or take weight measurements each day. By monitoring the observation and health events received by the event engine 215, the task evaluation service node 114F determines whether the patient has complied with the care protocol. If not, the task evaluation service node 114F triggers a health event with a corresponding action for the event engine 215 to perform such as sending a notification to the patient using notification service 325 or informing a care provider using the monitoring service 330.

### Data Synchronization Between Devices

In a health care environment that includes computing devices, mobile devices and social/collaborative applications, it is desirable to allow data to be updated on an individual's own devices or to allow the data to be manipulated by multiple users on their own devices simultaneously. As an example, sensor devices (e.g., a heart monitoring device) can generate substantial amounts of biometric data for the patient (e.g., electrocardiogram (ECG) data), while computing devices for the health care provider can generate changes to the patient's care plan. In such an environment, data synchronization techniques can be used in order to ensure that the various computing devices within the environment are operating with the most current data.

In many environments, particular computing devices may be offline for periods of time, during which these devices are unable to send and receive data for synchronizing with other devices. This can be particular problematic for devices with an intermittent network connection (e.g., devices relying on a cellular or WiFi network connection), as by the time a device is able to send data, the data may have already been updated from another device and the update is now obsolete. Moreover, a substantial amount of data can be collected in a health care environment and it may be infeasible for a device to sink all of the available data upon restoring its network connection. For example, a health care provider could activate a mobile device that has been off-line for several months in order to make a change to a patient's care plan and to review a patient's recent biometric data. In such a scenario, it may be impractical for such a mobile device to attempt to synchronize all of the data collected for the given patient over the past few months, particularly as the health care provider only wishes to view and modify a small portion of said data.

As such, embodiments described herein provide mechanisms for synchronizing data across multiple sources, where any of those sources could be updating any of the data at any time. For example, embodiments described herein may be used to intelligently and selectively synchronize data between the various devices used to administer a care plan for a patient. Moreover, embodiments may be used in environments where the various computing devices (e.g. a mobile device that is not within network range) may periodically be unable to access a master copy of the database, as protocols described herein can determine which devices need to send and receive which data.

One embodiment provides techniques for synchronizing data between devices (e.g., a mobile device configured to collect biometric data for a patient using sensor devices, a computing device for use by health care providers to edit a patient's care plan, a database server, etc.). A first device can transmit a sync request to a second device to initiate a sync operation. Such a sync request could include one or more identifiers assigned to data elements to be synchronized. As an example, a patient's mobile device could transmit such a sync request to a database server upon obtaining network connectivity, and the sync request could include an identifier(s) corresponding to the patient's care plan to synchronize the patient's health care plan data, thereby ensuring the mobile device is operating with the latest version of the care plan.

The sync request could also specify a session identifier value for each data element identifier within the request. Generally, the session identifier values indicate when the last sync operation was performed for the respective data element. In one embodiment, the session identifier values correspond to the value of a counter that is incremented each time a sync operation is performed. In such an embodiment, after updating a particular data element value as part of a sync operation, logic on the device can increment the current session identifier value and can tag the updated data element value with the incremented session identifier value. More generally, any value or values capable of indicating identifying a sync operation and/or when a sync operation was performed may be used, consistent with the functionality described herein.

Additionally, the sync request can include one or more data element values that have been modified on the first device since the last sync operation performed by the first device. That is, not only could the first device's data be outdated due to the first device is loss of network connectivity for a period of time, but other devices in the health care environment could have outdated data because they do not include the data updates performed on the first device during the first device is loss of connectivity. For example, biometric data for the patient could still be collected while the patient's mobile device is out of network range. As such, the sync request can include data modifications made on the first device since the last sync operation, including new data element values (e.g., newly collected biometric data for the patient), modified data element values (e.g., a change to a threshold value in a patient's health care plan), deleted values (e.g., a deleted condition in a patient's health care plan), and so on.

Upon receiving the sync request from the first device, the second device can process the included data element modifications. For instance, if the second device determines that a data element modification within the sync request is more recent than a copy of the data element on the second device, the second device could incorporate the data element modification into its local data repository. In doing so, the second device could compare the session identifier within the sync request with a session identifier stored on the local device to determine whether the data element modifications in the sync request are more recent than the corresponding data element values on the second device. As an example, upon determining that the session identifier within the synchronization request is more recent than a second session identifier for a corresponding copy of the data element maintained at the second device, the second device could update the first data element based on the one or more data element values specified within the synchronization request. As another example, upon determining that the session identifier within the synchronization request is older than a second session identifier for the corresponding data element maintained at the second device, the second device could simply discard the data modification.

In addition to updating the data repository on the second device in response to the sync request, the second device can be configured to return data values to the first device. For instance, the second device could identify data elements in the second device's data repository having a respective session identifier that is more recent than the session identifier specified within the synchronization request. That is, the second device could identify data elements that have been updated more recently than the session identifier specified within the sync request. The second device could then transmit data values for the identified data elements to the first device, and the first device could update its local data repository based on the received data values. Doing so provides a way of synchronizing the first device and the second device, even when one of the devices loses network connectivity for some period of time.

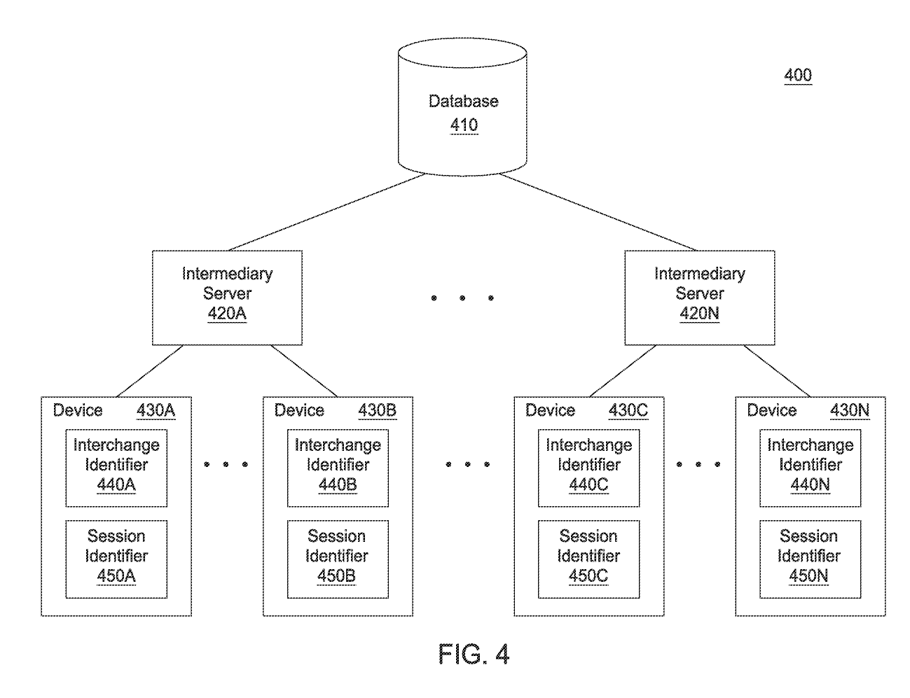

In one embodiment, the devices used to administer a care plan for patient are arranged in a hierarchical structure. An example of this is shown in FIG. 4, which is a block diagram illustrating care plan devices arranged in a hierarchical topology, according to one embodiment described herein. As shown, the system 400 includes a central database 410, intermediary servers 420A-N and endpoint devices 430A-N. Each of the endpoint devices 430A-N includes a respective interchange identifier 440A-N and a respective session identifier 450A-N. Generally, the interchange identifiers 440A-N are used to uniquely identify their respective devices 430A-N within the health care environment. For example, an interchange identifier 440 could be assigned at the time the devices 430 are registered during the creation of the central database 410.

The session identifiers 450A-N are generally used to specify when a sync operation last occurred for a given data value. For example, logic on the device 430A could update a particular data element as part of a sync operation and could then tag the particular data element with the session identifier 450A. The logic could also increment the session identifier 450A as part of each sync operation. Doing so enables devices within the system 400 to quickly and easily determine which data values to include as part of a sync operation, based on the session identifiers associated with the data values. For example, the device 430A could transmit a sync request to sync a particular data type to intermediary server 420A, specifying a session identifier that identifies when the previous sync operation was performed between the device 430A and the intermediary server 420A for the particular data type. The intermediary server 420A could then return all new data values and data value modifications that are more recent than the specified session identifier to the device 430A (e.g., as determined based on a comparison between the session identifier specified in the sync request and the session identifiers the data values on the intermediary server 420A are tagged with).

The devices 430A-N can generally use the interchange identifiers 440A-N to ensure that any data elements created on the devices 430A-N are assigned an identifier that is unique within the health care environment. For example, a device 430 could tag each data element on the device 430 with both the devices interchange identifier 440 and an interchange serial number, wherein the interchange serial number represents a unique identifier within the device 430. As these interchange serial numbers are unique with respect to the given device and since each device is assigned a unique interchange identifier 440, this ensures that every data element on the devices 430A-N is tagged with a unique identifier.

Additionally, as discussed above, the devices 430A-N can each maintain a session identifier that indicates the last time a sync operation was performed on the respective device. After successfully exchanging data elements with another device, a device 430 can increment its session identifier. Moreover, the device 430 can tag each data value updated during the sync operation with the current session identifier. Doing so enables the device to quickly determine which data values should be updated as part of a subsequent sync operation. As an example, assuming that device 430A performs a sync operation with intermediary server 420A, and that device 430A includes a data element tagged with a session identifier of “1000”, while intermediary server 420A includes the same data element tagged with a session identifier of “1100”. In performing the sync operation, the device 430A could specify its session identifier of 1000 for the data element. Upon receiving the sync request, logic on the intermediary server 420A could compare the two session identifiers and could determine that the intermediary server's instance of the data element is more current than the device's instance of the data element. As such, the intermediary server 420A could return its value for the data element in question as part of the sync operation.

Additionally, in a hierarchical arrangement such as in the system 400, an intermediary device can perform a sync operation with its parent device, in response to receiving a sync request from a child device. Doing so ensures that the most up-to-date data is returned to the child device in response to the received sync request. For example, upon receiving a sync request from the device 430A designating one or more data types to be synchronized, the intermediary server 420A could transmit a second sync request specifying the one or more data types to the database 410. Once the synchronization operation with the database 410 is complete, the intermediary server 420A could return any modifications to the designated one or more date types to the device 430A. This ensures that the device 430A is provided with the most up-to-date data from both the intermediary server 420A and the database 410.

Moreover, if the sync request sent by the device 430A includes one or more data element modifications made on the device 430A, the intermediary server 420A could include those data element modifications in the second sync request sent to the database 410. Similarly, this ensures that both the intermediary server 420A and the database 410 are provided with the most up-to-date data from the device 430A. For example, the device 430A could be a mobile device configured to communicate with one or more biometric sensors in a patient care environment, and the device 430A could transmit all biometric data that was collected since the previous sync operation with the intermediary server 420A as part of the sync request. In turn, the intermediary server 420A could include the biometric data in the second sync request that is sent to the database 410.

In a particular embodiment, such data element modifications may be substantial in size. For example, a patient device that has been without network connectivity for a substantial period of time could have collected a substantial amount of biometric data for the patient. In such a scenario, it may be impractical to include all of the data element modifications since the last sync operation was performed in the sync request to a parent device (e.g., an intermediary server 420). As such, the devices can be configured to include identifiers of the updated data elements in the sync request, without including the values of the data elements. If the parent device receiving the sync request then wishes to retrieve these updated data elements, the parent device can transmit a subsequent request specifying the identifiers corresponding to the data elements the parent device wishes to retrieve values for. Doing so makes the parent device aware of the data element modifications at the requesting device and allows the parent device to retrieve any or all of the data element modifications as needed.

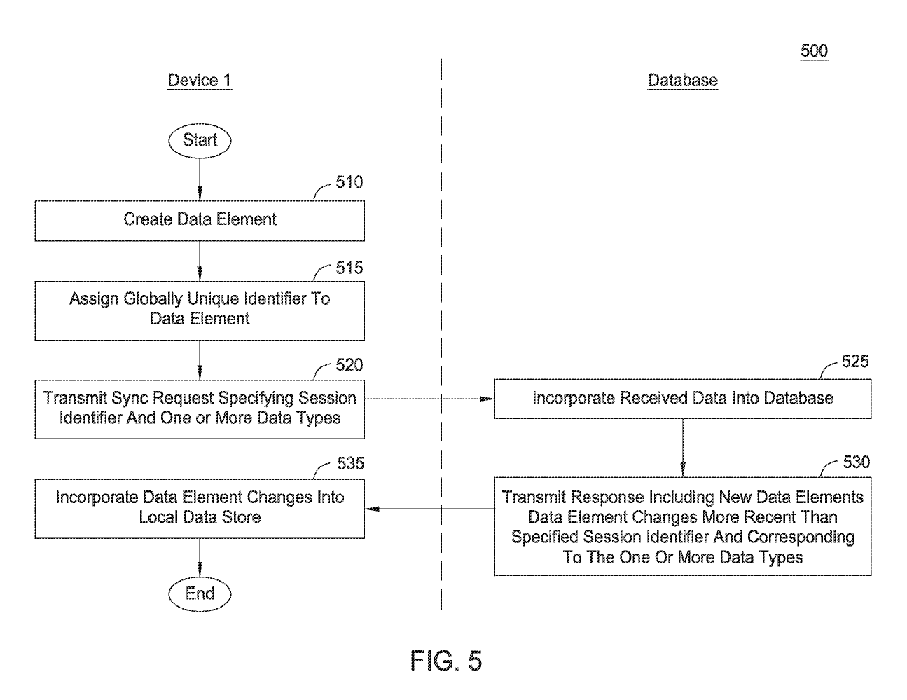

FIG. 5 is a flow diagram illustrating a method of synchronizing data between devices, according to one embodiment described herein. As shown, the method 500 begins at block 510, where a monitoring application 136 on a first device creates a data element. The monitoring application 136 then assigns a globally unique identifier to the created data element (block 515). Generally, as discussed above, the assigned identifier is unique within at least the health care environment for the patient in question. For instance, the monitoring application 136 could create the identifier by combining an interchange serial identifier that is unique within the workspace of the device on which the monitoring application 136 is executing and an interchange identifier assigned to the device and unique within the health care environment. Doing so provides a unique identifier for the created data element across all of the devices within the patient's health care environment.

Generally, blocks 510 and 515 can be repeated any number of times. At some point, the first device transmits a sync request specifying a session identifier for the created data element (or, in the case blocks 510 and 515 are repeated multiple times, a session identifier for each created data element) and specifying one or more date types to synchronize (block 520). For example, the first device could transmit the sync request upon a user launching a particular interface of a health care application on the first device. As another example, the first device could transmit the sync request upon successfully connecting to a network, e.g., a cellular network, a Wi-Fi network, etc.

Upon receiving the sync request, the database incorporates the received data element value (block 525). In doing so, logic for the database could compare the session identifier for the data element specified within the sync request with a session identifier corresponding to the databases version of the data element, in order to determine which version of the data element is more recent. In the depicted embodiment, the logic for the database has determined that the session identifier for the data element specified within the sync request is more current, and thus has incorporated the received data element value into the database. In the event the database logic determines that it's local version of the data element is more current than the data element value within the sync request (i.e., by comparing the session identifiers), the database logic could simply discard the data element value received from the first device, as such a data element value is outdated.

The logic for the database then transmits a response to the first device including any new data element values and data element changes (e.g., data element modifications, data element deletions, etc.) more recent than the specified session identifier and corresponding to the one or more data types specified in the sync request (block 530). For example, in selecting the data values to include in the response, the database logic could compare the session identifier specified in the sync request with respective session identifiers for each data element of the one or more data types in the database, and could return all data values tagged with a session identifier more recent than the session identifier specified in the request. At block 535, upon receiving the response, logic for the first device incorporates the received data element changes into it's local data store (e.g., a database on the first device), and the method 500 ends. Doing so provides an intelligent and efficient manner of synchronizing data between the first device and the database.

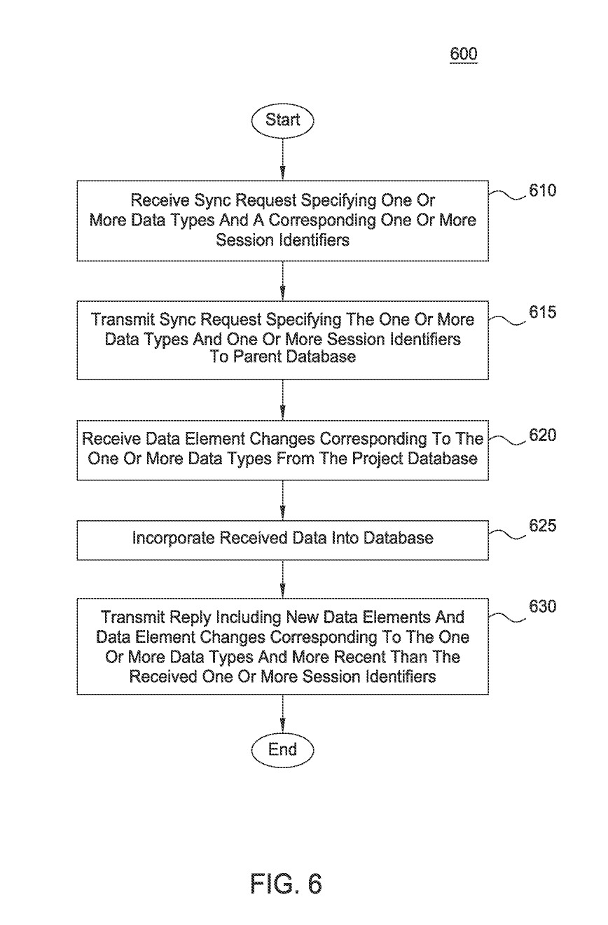

FIG. 6 is a flow diagram illustrating a method of synchronizing data at an intermediary device, according to one embodiment described herein. As shown, the method 600 begins at block 610, where logic for a database receives a sync request from a remote device specifying one or more date types to synchronize and a corresponding one or more session identifiers. For example, the sync request could include a session identifier for each specified data type, indicating when a last sync operation was performed for the respective data type.

As discussed above, such a sync request can also include data element modifications made by the remote device since the remote devices previous sync operation. For instance, the sync request could include the data element values themselves. As another example, the sync request could include identifiers (and session identifiers) for the modified data elements, which the database logic could then use to subsequently retrieve the data element values from the remote device.

In the depicted embodiment, the database logic transmits a second sync request specifying the one or more date types and one or more session identifiers to a parent database (block 615). That is, in the present example, the particular database is an intermediate database (e.g., a database on an intermediary server 420) and is configured to perform a sync operation with the parent database (e.g., database 410) for the requested date types, before responding to the sync request from the remote device. Doing so ensures that the response to the remote device includes the most up-to-date data, as the response will include the most recent data from both the present database as well as the parent database. Generally, the session identifiers included in the request can be used to determine when a last sync operation was performed for the corresponding data type between the intermediary database and the parent database.

Additionally, as discussed above, the second sync request can include data element modifications made in the present database since the previous sync operation between the present database and the parent database, including the data element modifications received in the first sync request from the remote device. This ensures that the present database will have the most up-to-date data from the remote device, and further ensures that the parent database will have the most up-to-date data from both the remote device and the present database. Of note, while the present example involves only a single parent database, the described techniques could be employed in a hierarchical topology of any size. That is, the present database could perform a sync operation with its parent upon receiving the sync request from the remote device, and the parent database could perform a sync operation with its parent, and so on until the top of the hierarchical structure is reached.

In some embodiments, the parent sync request is selectively performed. For example, in one embodiment, the requestor can specify in the sync request whether to perform the additional sync operations with one or more parent databases within the hierarchical topology. That is, particular applications and application operations can operate with stale data, and thus a sync request for those applications and application operations could indicate that the sync request does not need to be propagated to the next tier(s) of the hierarchical topology. On the other hand, other applications may require absolutely current data (e.g., data relating to administering a patient's care plan) and thus sync operations for such applications could specify that the sync operation is to be propagated to the top of the hierarchical topology.

In response to the second sync request, the database logic receives data element changes corresponding to the specified one or more date types from the parent database (block 620). As discussed above, the data element changes can include not only modifications to existing data values, but can include new data elements and deleted data elements as well. The logic for the present database incorporates the received data into the present database (block 625).

Additionally, the logic transmits a reply to the remote device including new data elements and data element changes corresponding to the one or more data types and more recent than the received one or more session identifiers (block 630), and the method 600 ends. For example, the logic could compare the session identifiers within the received request with session identifiers associated with data values in the database, to determine which data values of the specified one or more data types are more recent than the received session identifier, and could include those data values (or corresponding changes relating to those data values) in the response. By performing the second sync operation with the parent database, the method 600 ensures that the reply to the remote device includes all data element modifications corresponding to the specified one or more date types within both the present database and the parent database.

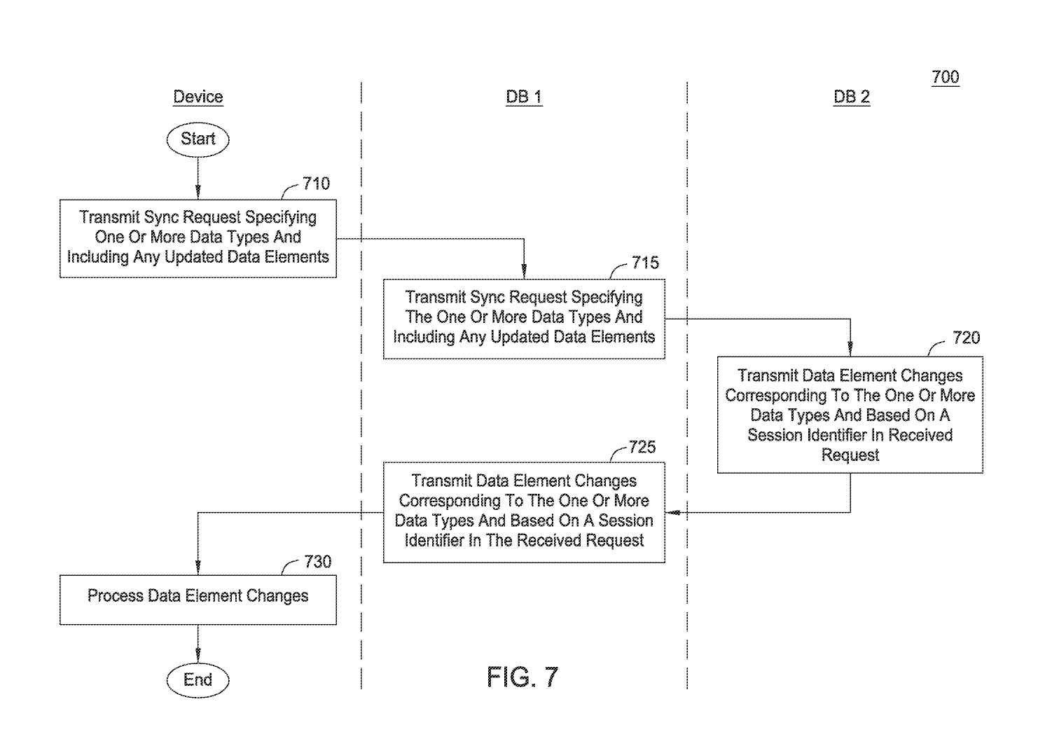

FIG. 7 is a flow diagram illustrating a method of synchronizing data between devices, according to one embodiment described herein. As shown, the method 700 begins at block 710, where a device transmits a sync request specifying one or more date types and including any data elements that have been updated since a previous sync request between the device and the first database. Additionally, such a sync request can include a session identifier for each data element indicating when the data element was last modified on the device.

Upon receiving the sync request, the first database transmits a second sync request to the second database, the second sync request specifying the one or more date types and including any data elements that have been modified on the first database since a previous sync operation between the first and second databases (block 715). Although not shown, logic for the first database can also incorporate any or all of the data elements included in the first sync request into the first database. In doing so, the first database logic can compare the session identifier for each that element modification within the sync request with a session identifier for the corresponding data element within the first database to determine which data element value is the most current.

Upon receiving the sync request from the first database, the logic for the second database transmits data element changes corresponding to the one or more date types and determined based on the session identifiers within the received sync request (block 720). For example, the second database could return all data element changes to the requested date types that have occurred since a previous sync operation between the first database and the second database. As another example, the logic for the second database could determine that the second database's value for a particular data element is more recent than the data element modification specified within the sync request, based on a comparison of the respective session identifiers. In response to such a determination, the second database logic could include its instance of the particular data element in the reply to the first database.

Upon receiving the response from the second database, the logic for the first database can incorporate the received data element changes into the first database. In addition, the logic for the first database can increment a session identifier for the first database and can tag each data element in the first database that was modified as part of the sync operation with the session identifier. In the depicted embodiment, the logic for the first database also generates a response that includes data element changes corresponding to the requested date types and transmits such a response to the device (block 725). Upon receiving the response, logic on the device processes the received data element changes against a database on the device (block 730), and the method 700 ends. Additionally, the logic for the device can increment a session identifier for the device and can tag each data element in the device's database that was modified as part of the sync operation with the session identifier. Doing so enables the device to quickly determine which data elements have pending updates in subsequent sync operations.

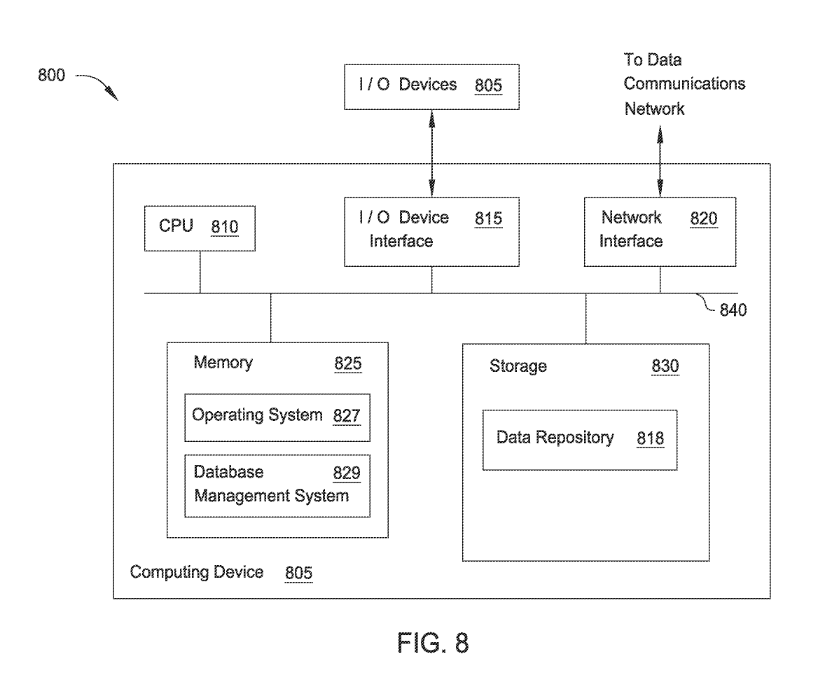

FIG. 8 illustrates a computing environment 800 for processing health events, according to one embodiment. As shown, computing device 805 includes, without limitation, a central processing unit (CPU) 810, a network interface 820, a memory 825, and storage 830, each connected to a bus 840. The computing device 805 also includes an I/O device interface 815 for connecting to I/O devices 805 (e.g., keyboard, display and mouse devices) in the environment 800. Further, in context of this disclosure, the computing elements shown in the computing device 805 may correspond to a physical computing system (e.g., a system in a data center) or may be a virtual computing instance executing within a computing cloud.

CPU 810 retrieves and executes programming instructions stored in memory 825 as well as stores and retrieves application data residing in the storage 830. The bus 840 is used to transmit programming instructions and application data between CPU 810, I/O devices interface 805, storage 830, network interface 820, and memory 825. Note, CPU 810 is included to be representative of a single CPU, multiple CPUs, a single CPU having multiple processing cores, and the like. Memory 825 is generally included to be representative of a random access memory. Storage 830 may be a disk drive storage device. Although shown as a single unit, storage 830 may be a combination of fixed and/or removable storage devices, such as fixed disc drives, removable memory cards, network attached storage (NAS), or a storage area-network (SAN).

Illustratively, memory 825 includes an operating system 827 and a database management system (DBMS) 829, while storage 830 includes a data repository 818 (e.g., a database). The operating system 827 generally controls the execution of application programs on the computing device 805. Examples of operating system 827 include, without limitation, versions of UNIX, distributions of the Linux® operating system, versions of Microsoft® Windows® and so on. The DBMS 829 generally facilitates the capture and analysis of data in the data repository 818. For instance, the DBMS 829 could enable the definition, creation, querying, update and administration of the data repository 818. As an example, the DBMS 829 could receive a query (e.g., composed using Structured Query Language (SQL) and, in response, could generate an execution plan that includes one or more access routines to be run against the data repository 818. The DBMS 829 could then execute the access routine(s) and could return any query result data to the requestor.

Memory 825 may also include processing nodes (not shown). Such processing nodes may be assigned to the same CPU 810 or to different CPUs. Further, each processing node may include respective sets of consumers (e.g., processes or threads) that are assigned to process different priority health events. Such a consumer could monitor upstream queues, and when idle, retrieve and process health events that are assigned the same priority level.

One embodiment of the present disclosure is implemented as a program product for use with a computer system. The program(s) of the program product defines functions of the embodiments (including the methods described herein) and can be contained on a variety of computer-readable storage media. Examples of computer-readable storage media include (i) non-writable storage media (e.g., read-only memory devices within a computer such as CD-ROM or DVD-ROM disks readable by an optical media drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present disclosure, are embodiments of the present disclosure. Other examples media include communications media through which information is conveyed to a computer, such as through a computer or telephone network, including wireless communications networks.

In general, the routines executed to implement the embodiments of the present disclosure may be part of an operating system or a specific application, component, program, module, object, or sequence of instructions. The computer program of the present disclosure is comprised typically of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the disclosure. However, it should be appreciated that any particular program nomenclature that follows is used merely for convenience, and thus the present disclosure should not be limited to use solely in any specific application identified and/or implied by such nomenclature.

As described, embodiments herein provide techniques for processing health events in a workflow based on different priority levels. The processing nodes may include respective sets of consumers that are assigned to process health events with different priority levels. Advantageously, the system can adapt to changing different workloads by adding or removing event engines/servers as well as changing the number of consumers in the processing nodes.

While the foregoing is directed to embodiments of the present disclosure, other and further embodiments of the disclosure may be devised without departing from the basic scope thereof, and the scope thereof is determined by the claims that follow.

What is claimed is:

1. A method of synchronizing data between a first device and a second device, comprising:
creating a plurality of data elements relating to a care plan in a health care environment for a patient;
assigning a respective identifier to each of the plurality of data elements, wherein each assigned identifier is unique within the health care environment;
transmitting a synchronization request to a second device, specifying at least (i) one or more identifiers assigned to data elements to synchronize, (ii) a session identifier indicating when a last synchronization operation was performed at the first device and (iii) one or more data element values that have been modified since the last synchronization operation was performed;
in response, receiving a second one or more data element values from the second device, corresponding to the one or more identifiers specified in the synchronization request; and
updating, at the first device, the one or more data elements corresponding to the second one or more data element values.

2. The method of claim 1, wherein a first data element in the plurality of data elements comprises biometric data for a patient generated by one or more sensor devices.

3. The method of claim 1, wherein a first data element in the plurality of data elements comprises a health care event that specifies one or more conditions that, when satisfied, designate an occurrence of the health care event.

4. The method of claim 1, wherein assigning the respective identifier to each of the plurality of data elements further comprises:
determining a device identifier that uniquely identifies the first device within the health care environment for the patient;
determining a respective data element identifier for each of the plurality of data elements; and
tagging each of the plurality of data elements with the respective identifier that includes the determined device identifier and the respective data element identifier.

5. The method of claim 1, wherein the synchronization request further specifies a deleted flag for one of the plurality of data elements, indicating that the data element has been deleted on the first device.

6. The method of claim 1, further comprising:
further in response to transmitting the synchronization request, receiving a deleted flag for a data element corresponding to the one or more identifiers specified in the synchronization request, indicating that the data element has been deleted by a device other than the first device.

7. The method of claim 1, wherein updating, at the first device, the one or more data elements corresponding to the second one or more data element values further comprises:
incrementing the session identifier indicating when the last synchronization operation was performed at the first device; and
tagging each of the one or more updated data elements with the incremented session identifier.

8. A non-transitory computer-readable medium containing computer program code that, when executed by a processor, performs an operation for synchronizing data between a first device and a second device, comprising:
creating a plurality of data elements relating to a care plan in a health care environment for a patient;
assigning a respective identifier to each of the plurality of data elements, wherein each assigned identifier is unique within the health care environment;
transmitting a synchronization request to a second device, specifying at least (i) one or more identifiers assigned to data elements to synchronize, (ii) a session identifier indicating when a last synchronization operation was performed at the first device and (iii) one or more data element values that have been modified since the last synchronization operation was performed;
in response, receiving a second one or more data element values from the second device, corresponding to the one or more identifiers specified in the synchronization request; and
updating, at the first device, the one or more data elements corresponding to the second one or more data element values.

9. The non-transitory computer-readable medium of claim 8, wherein a first data element in the plurality of data elements comprises biometric data for a patient generated by one or more sensor devices.

10. The non-transitory computer-readable medium of claim 8, wherein a first data element in the plurality of data elements comprises a health care event that specifies one or more conditions that, when satisfied, designate an occurrence of the health care event.

11. The non-transitory computer-readable medium of claim 8, wherein assigning the respective identifier to each of the plurality of data elements further comprises:
determining a device identifier that uniquely identifies the first device within the health care environment for the patient;
determining a respective data element identifier for each of the plurality of data elements; and
tagging each of the plurality of data elements with the respective identifier that includes the determined device identifier and the respective data element identifier.

12. The non-transitory computer-readable medium of claim 8, wherein the synchronization request further specifies a deleted flag for one of the plurality of data elements, indicating that the data element has been deleted on the first device.

13. The non-transitory computer-readable medium of claim 8, the operation further comprising:
further in response to transmitting the synchronization request, receiving a deleted flag for a data element corresponding to the one or more identifiers specified in the synchronization request, indicating that the data element has been deleted by a device other than the first device.

14. The non-transitory computer-readable medium of claim 8, wherein updating, at the first device, the one or more data elements corresponding to the second one or more data element values further comprises:
incrementing the session identifier indicating when the last synchronization operation was performed at the first device; and
tagging each of the one or more updated data elements with the incremented session identifier.

15. A system, comprising:
a processor; and
a memory containing a program that, when executed by the processor, performs an operation for synchronizing data between a first device and a second device, comprising:
creating a plurality of data elements relating to a care plan in a health care environment for a patient;
assigning a respective identifier to each of the plurality of data elements, wherein each assigned identifier is unique within the health care environment;
transmitting a synchronization request to a second device, specifying at least (i) one or more identifiers assigned to data elements to synchronize, (ii) a session identifier indicating when a last synchronization operation was performed at the first device and (iii) one or more data element values that have been modified since the last synchronization operation was performed;
in response, receiving a second one or more data element values from the second device, corresponding to the one or more identifiers specified in the synchronization request; and
updating, at the first device, the one or more data elements corresponding to the second one or more data element values.

16. The system of claim 15, wherein a first data element in the plurality of data elements comprises at least one of (i) biometric data for a patient generated by one or more sensor devices and (ii) a health care event that specifies one or more conditions that, when satisfied, designate an occurrence of the health care event.

17. The system of claim 15, wherein assigning the respective identifier to each of the plurality of data elements further comprises:
determining a device identifier that uniquely identifies the first device within the health care environment for the patient;
determining a respective data element identifier for each of the plurality of data elements; and
tagging each of the plurality of data elements with the respective identifier that includes the determined device identifier and the respective data element identifier.

18. The system of claim 15, wherein the synchronization request further specifies a deleted flag for one of the plurality of data elements, indicating that the data element has been deleted on the first device.

19. The system of claim 15, the operation further comprising:
further in response to transmitting the synchronization request, receiving a deleted flag for a data element corresponding to the one or more identifiers specified in the synchronization request, indicating that the data element has been deleted by a device other than the first device.

20. The system of claim 15, wherein updating, at the first device, the one or more data elements corresponding to the second one or more data element values further comprises:
incrementing the session identifier indicating when the last synchronization operation was performed at the first device; and
tagging each of the one or more updated data elements with the incremented session identifier.
